(19) United States
(12) Patent Application Publication
(10) Pub. No.: US 2005/0256255 A1
(43) Pub. Date: Nov. 17, 2005

(54) Film coating

(76) Inventors: Ola Karlsson, Lund (SE); Lars Johan Pontus de Verdier Hjartstam, Molndal (SE); Staffan Schantz, Molndal (SE)

Correspondence Address: WHITE & CASE LLP;PATENT DEPARTMENT, 1155 AVENUE OF THE AMERICAS, NEW YORK, NY, 10036, US

(21) Appl. No.: 10/511,115

(22) PCT Filed: Apr. 9, 2003
(86) PCT No.: PCT/GB03/01531

§ 371 Date: Jun. 23, 2005

(30) Foreign Application Priority Data
Apr. 12, 2002 (SE) 0201110-4

(51) Int. Cl. C08F 20/44

(52) U.S. Cl. 524/556; 526/317.1

(57) ABSTRACT

The present invention provides a novel film coating dispersion obtainable by the polymerization of the following monomers in water: acrylic acid or an ester thereof in the range 40 to 80% by weight; methacrylic acid or an ester thereof in the range 20 to 60% by weight; and a polymerizable surfactant in the range 0.01 to 9% by weight. The dispersion is suitable for coating pharmaceutical formulations to provide controlled release of the active ingredient.

### FIELD OF THE INVENTION

The present invention relates to a new film coating. More specifically the present invention relates to a new film coating for the achievement of controlled release from pharmaceutical formulations such as tablets, pellets, etc., wherein the film coating may be applied in a substantially aqueous environment. Furthermore, the invention provides a process for the preparation of such a film coating.

### BACKGROUND OF THE INVENTION

Oral administration of a drug is the most convenient for the patient. Proper formulations must also meet the requirements of safety and simplicity. Depending on the properties of a drug and the therapeutic requirements, the drug is formulated differently so that the drug has the desired release profile.

For many active substances or drugs it is desirable that the formulation results in the controlled release of the active substance or drug. An example of such an active substance is metoprolol. In principle two main types of controlled-release formulation dosage forms exist; the matrix system where the drug is mixed with the matrix material (often a polymer or a wax); and the drug reservoir system where the drug is formulated into a core (tablet or pellets) surrounded by a polymeric film. The film is then a release rate-controlling barrier determined by, e.g., its dissolution rate, its permeability, the solubility of the substance, etc.

A popular controlled-release formulation includes film coating a drug which is in small discrete units. By formulating the drug into discrete units covered by a film coating, the formulation has several interesting features, e.g., flexibility in dosage and modification of release properties, different dosage forms can be developed, dose size is adaptable to suit fixed combinations, tablets can be made divisible, etc. In a number of studies it was shown that safe, simple, and convenient therapy could be achieved utilising this principle for the drug metoprolol and its salts (Ragnarsson et al, Drug Develop Ind Pharmacy 13, 1495 (1987); Sandberg et al, Eur J Clin Pharmacol 33, S3 (1988) and S9 (1988); Ragnarsson et al, Int J Pharmaceutics 79, 223 (1992); Sandberg et al, Ibid 68, 167 (1991); Sandberg et al, Pharmaceutical Res 10, 28 (1993); Sandberg et al, Drug Invest 6, 320 (1993); Sandberg, Thesis Uppsala University, 1994).

The formulation of metoprolol into pellets according to the above mentioned references utilised a film coating sprayed from a solution of ethyl cellulose and hydroxypropyl methyl cellulose in an organic solvent. However, for environmental reasons it will be necessary in the near future to utilise water based film forming systems for this and other drugs to be formulated as pellet systems. Also, tablet coatings in general utilising organic solvents must for the same reasons be exchanged with water based film forming materials. Thus, much effort has been directed to find suitable water based systems for film coatings in drug delivery systems.

Water based film-forming polymer latexes for the pharmaceutical industry have been known since the early eighties when commercial dispersions more frequently appeared on the market (e.g., Aquacoat, FMC Corp.; Eudragit E-30D, Röhm Pharma). Further development has given several other products that have been tested and reported in a number of publications (Petereit and Weisbrod, Eur J Pharmaceutics and Biopharm 47, 15 (1999); Petereit et al, Ibid, 41, 219 (1995); Amighi and Moës, STP Pharma Sci 7, 141 (1997); Bodmeier and Paeratukul, Pharm Res 11, 882 (1994); Ozturk et al, J Controlled Release 14, 203 (1990). Goodhart et al, Pharmaceutical Tech April, 64 (1984); Bodmeier and Paeratakul Int J Pharmaceutics 152, 17 (1997); Bodmeier and Paeratakul Drug Develop Ind Pharmacy 20, 1517 (1994)).

A problem with water based film-forming polymers is that to obtain good properties for the film coating anti-sticking agents need to be added. Anti-sticking agents, also named detackifiers, glidants, and lubricants, are well-known agents and can often result in the film coating not being easy to work with. Commonly used anti-sticking agents include glyceryl monostearate (GMS), talc, and silica. However, often these agents must first be dispersed with other added materials, preferably surfactants or amphiphilic polymers, to obtain more homogeneous systems.

A popular film coating dispersion is Eudragit® NE30D (Röhm). Eudragit® NE30D has a low glass transition temperature (Tg) and contains approximately 28.5% w/w particles of the copolymer poly(ethylacrylate-co-methylmethacrylate), and approximately 1.5% w/w of the non-ionic tenside Nonoxynol 100 (a polyoxyethylated nonylphenol) as the stabiliser. However, to obtain best spraying conditions and technical appearance of the film-coated pellets, the anti-sticking agent GMS has to be added to the dispersion as reported by Petereit et al. 1995 (supra) and Petereit and Weisbrod, (1999) (supra). However, for best performance of the dispersion during spraying the GMS was dispersed with an extra surface active agent, e.g., polysorbate 80 (PS80). On the other hand, we have found that it has been difficult to obtain results with acceptable reproducibility with respect to, e.g., permeability and release rates from formulations manufactured according to these suggested procedures. One tentative explanation for this might be that the properties of the GMS/PS80 dispersion, e.g., size of dispersed particles, highly depend on process parameters like temperature, type of mixing etc, which also can be concluded from the results by Petereit et al. 1995 (supra) and Petereit and Weisbrod, (1999) (supra).

The addition of anti-sticking agents, and the addition of surface active molecules, talc or stearates with Eudragits for the controlled release of different types of drugs has been reported by a large number of groups including Wolff et al, WO 00/13687; Wolff et al, WO 00/13686; Nagy et al, WO 99/42087; Lee et al, WO 99/30685; Eichel et al, U.S. Pat. No. 5,529,790; Eichel U.S. Pat. No. 5,478,573; Chen, U.S. Pat. No. 5,260,068; Petereit et al, EP 403,959.

Examples of other dispersions known in the field are Kollicoat® SR30D (BASF), Eudragit® RL30D (Röhm) and Eudragit® RS30D (Röhm). However, due to their high Tg these polymer dispersions form brittle films and need therefore a plasticizer such as triacetin, triethyl citrate (TEC) or acetyl triethyl citrate (ATEC) in order to be useful for coating application and film formation (Kolter, K et al., Proc. Int. Symp. Controlled Release Bioact. Mater., 27, 425, 2000; G Cole (Ed) Pharmaceutical Coating Technology, Taylor and Francis Ltd 1995). However, the use of the plasticizer in a film coating can have a destabilizing effect on the film, probably caused by the migration of small molecules, which can result in the film coating exhibiting changes in its properties with time (see e.g., Gutiérrez Rocca, PhD Thesis The University of Texas at Austin, 1993). Also, the presence of stabilizers of the latex particles in a dispersion creates similar problems as, e.g., added plasticizers; i.e., migration of the stabilizers in the film, which can result in the film coating exhibiting changes in its properties with time.

Thus, available latex polymers when used as coating materials present three major problems: (a) sticky pellets may result, due to a low Tg, which then would need extra antisticking agents, or other additives\excipients, (b) brittle pellets may result, due to a high Tg, which then would need extra plasticizer or other additives\excipients, and (c) migration of additives\excipients, e.g., stabilizers for example emulsifiers, in the film, which then might exhibit changes in properties with time.

JP 01-113322 discloses an emulsion which is suitable for coating drugs to provide slow release which comprises ethyl acrylate (EA)-methyl methacrylate (MMA)-2-hydroxy ethyl methacrylate (HEMA). The ratio of copolymerized monomers in the copolymer EA:MMA is 3:1 to 1:3 and that of HEMA to (EA and MMA) is 1:2 to 1:10. Further details of these formulations are given in the three papers below.

Delayed release lactose microcapsules film-coated with copolymers produced by emulsion polymerization of aqueous dispersions of ethyl acrylate (EA)-methyl methacrylate (MMA)-2-hydroxy ethyl methacrylate (HEMA) are disclosed in Chem. Pharm. Bull. 36 (8) 3070-3078 (1988). The molar ratios of the EA, MMA and HEMA used were 12:6:X, 9:9:X and 6:12:X where X is 4, 6 or 8. The emulsifier used was sodium dodecyl sulfate (SDS).

The properties of such film coats were further reported in Chem. Pharm. Bull 41(6) 1342-1136 (1993). The conclusion to this paper was that no monomer composition of copoly(EA-MA-HEMA) was found which exhibited all of the following: a low degree of agglomeration; a low permeability and a high yield of polymer.

Chem. Pharm. Bull 42(6) 1308-1314 (1994) discloses that the use of blend copolymer latexes or composite core shell latexes is necessary to obtain the required combination of properties e.g. agglomeration, low membrane permeation and high coating efficiency, required to produce a film comprising EA, MMA and HEMA which can successfully microencapsulate lactose. The molar ratios of EA, MMA and HEMA used were EA, MMA and HEMA in 6:12:8 and 12:6:4.

In the three papers mentioned immediately above much higher amounts of HEMA are used (typically in the range of 22 to 36% by weight of the polymer) than in the present invention. Also, there is no disclosure of the removal of emulsifier after polymerization.

U.S. Pat. No. 3,775,537 discloses film coats comprising copolymers of a hydroxyalkyl ester of an acrylic acid and at least one ester of acrylic acid or methacrylic acid with a C₁₋₈ alkanol wherein the polymerization and coating are done in an organic solvent.

EP 0228 879 discloses crosslinked polymers comprising ethyl acrylate, methyl methacrylate and a hydroxyalkyl ester of methacrylic acid or acrylic acid. Such crosslinked esters are not suitable for use in coating pharmaceutical compounds due to the possible presence of residual crosslinking agents which are reactive species.

### PURPOSE OF THE INVENTION

The purpose of the present invention is to provide a new film coating system that does not have the abovementioned problems. The advantages of the new film coating system are, for example, that no extra additives\excipients need to be added to the dispersion before the film forming process, and that non-stickiness and reproducibility are achieved during processing. Another aspect of the invention is to provide a method for synthesising the polymer dispersions as well as manufacturing them into coated formulations, for example pellets or tablets, utilising this new film forming system.

### SUMMARY OF THE INVENTION

The invention is based on a novel copolymer. The applicants have found that this copolymer can be used as a water-based film-forming polymer to coat pharmaceutical cores. The film coating can serve as a barrier giving close to constant release (zero-order) from the formulation. In addition, the physical properties of the film produced are such that minimal processing problems, such as tackiness, are experienced. Moreover, the films can be reproducibly produced with these improved properties and are stable on storage.

### DETAILED DESCRIPTION OF THE INVENTION

The present invention provides a copolymer comprising the following monomers:
acrylic acid or an ester thereof in the range 40 to 80% by weight;
methacrylic acid or an ester thereof in the range 20 to 60% by weight; and
a polymerizable surfactant in the range 0.01 to 9% by weight.

Above and in the following the percentages refer to the percentage amount by weight of each monomer in the sum of the monomer weights. The sum of the percentages of each monomer is such that the total weight is always 100%.

The term acrylic acid or an ester thereof as used herein means one of the following or mixtures thereof: acrylic acid, an alkyl ester of acrylic acid particularly a C₁₋₄ alkyl ester for example a methyl, ethyl, propyl or butyl ester, or a hydroxylated acrylic ester.

The term methacrylic; acid or an ester thereof as used herein means one of the following or mixtures thereof: methacrylic acid, an alkyl ester of methacrylic acid particularly a C₁₋₄ alkyl ester for example a methyl, ethyl, propyl or butyl ester or a hydroxylated methacrylic ester.

The term polymerizable surfactant as used herein means an alkenyl monomer which is capable of polymerizing and is also surface active (e.g. a compound of formula I as described below, or surface active derivatives of maleic acid). A preferred alkenyl functional monomer has both hydrophobic and hydrophilic parts and is surface active so that if will bind to latex particle surfaces during and after synthesis. Examples of polymerizable surfactants include the following: Emulsogen R 109 (Clariant), Emulsogen R 307 (Clariant), Sinnoester CPM1-3 (Cognis), Maxemul 5010 (Uniqema), Maxemul 5011 (Uniqema), PEM63P (Laporte), PEM63E (Laporte), MPEG 230 MA (Prochema), MPEG 400 MA (Prochema), MPEG 550 MA (Laporte), MPEG 750 MA (Röhm), polyethylene glycol acrylates and methacrylates, alkyl polyethylene glycol acrylates and methacrylates, acrylate and methacrylate esters of copolymers of ethylene glycol and propylene glycol or butylene glycol. A preferred polymerizable surfactant is a monomer characterized by formula I: 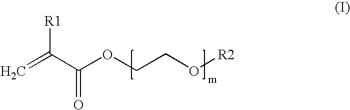
wherein m is an integer from 1-55,
R1 is hydrogen or methyl, and
R2 is hydrogen or a carbon chain having 1 to 20 carbon atoms.
   Mixtures of one or more polymerizable surfactants may also be used.

The amounts of the monomers are varied to control Tg and hydrophobicity/hydrophilicity.

Preferably the polymer of the invention comprises a copolymer between the following monomers:
ethyl acrylate in the range 40 to 80% by weight;
methyl methacrylate in the range 20 to 60% by weight; and
a monomer characterized by formula I: 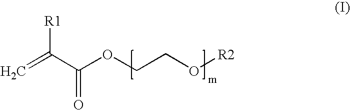
   wherein m is an integer from 1-55,
R1 is hydrogen or methyl, and
R2 is hydrogen or a carbon chain having 1 to 20 carbon atoms in the range 0.01 to 9% by weight.

It will be understood that the carbon chain in compounds of formula I is a saturated hydrocarbon chain of general formula CₙH₂ₙ₊₁ which may be straight or branched. For example a carbon chain having 3 carbon atoms could be propyl or isopropyl.

In another aspect the present invention provides an aqueous polymer dispersion obtainable by polymerization of the following monomers in water in the presence of an emulsifying agent:
acrylic acid or an ester thereof in the range 40 to 80% by weight;
methacrylic acid or an ester thereof in the range 20 to 60% by weight; and
a polymerizable surfactant in the range 0.01 to 9% by weight.

In yet another aspect the present invention provides an aqueous polymer dispersion obtainable by polymerization of the following monomers in water in the presence of an emulsifying agent:
ethyl acrylate in the range 40 to 80% by weight;
methyl methacrylate in the range 20 to 60% by weight;
and a monomer of formula I in the range 0.01 to 9% by weight.

Whilst not wishing to be bound by theory it is known that emulsifiers are necessary in an aqueous emulsion polymerization to facilitate a uniform polymerization reaction and that after the polymerization emulsifiers or surfactants are necessary to prevent agglomeration of the polymer particles produced. It is essential to have a uniform dispersion of the polymer in water at the start of a film coating process. However, we have found that the presence of residual emulsifier, eg sodium dodecyl sulfate, causes instability of the film coat produced which leads to deterioration of the release properties of the coated drug on storage. Further, it has surprisingly been found that if the amount of low molecular weight (lower than 15 kD) emulsifier (utilised in the polymerization process) in the copolymer dispersion is reduced or eliminated or replaced by a polymerizable non-ionic surfactant in the polymerization process then the final film coating has improved physical properties over time. The present invention has found methods of obtaining aqueous polymer dispersions which are stable with respect to agglomeration and can be used to form film coats with good delayed release properties that are not significantly affected by storage.

In another aspect the present invention provides an aqueous polymer dispersion obtainable by polymerization of the following monomers in water in the presence of an emulsifying agent:
acrylic acid or an ester thereof in the range 40 to 80% by weight;
methacrylic acid or an ester thereof in the range 20 to 60% by weight; and
a polymerizable surfactant in the range 0.01 to 9% by weight;
   wherein if the emulsifying agent is an emulsifier with a molecular weight lower than 15 kD then it is partially or fully removed after the polymerization reaction.

In yet another aspect the present invention provides an aqueous polymer dispersion obtainable by polymerization of the following monomers in water in the presence of an emulsifying agent:
ethyl acrylate in the range 40 to 80% by weight;
methyl methacrylate in the range 20 to 60% by weight;
and a monomer of formula I in the range 0.01 to 9% by weight;
   wherein if the emulsifying agent is an emulsifier with a molecular weight lower than 15 kD then it is partially or fully removed after the polymerization reaction.

Suitably if the emulsifier has a molecular weight lower than 15 kD then it is reduced to a total amount of less 0.67% w/w of the total polymer content of the dry film coat ultimately produced (for example in the range of 0.0001 to 0.67% w/w), preferably less than 0.5% w/w (for example in the range 0.001 to 0.5% w/w), more preferably less than 0.05% w/w (for example in the range of 0.01 to 0.05% w/w).

Suitably the reduction of the concentration or elimination of the emulsifier is carried out by techniques known in the art. These include (M C Wilkinson et al. Advances in Colloid and Interface Science 81, 77 (1999)), but are not limited to, dialysis, microfiltration, serum exchange, ultrafiltration, diafiltration, cross-flow microfiltration, centrifugation-decantation, ion-exchange, exchange with resins, activated charcoal cloth, steam stripping, gel filtration and special polymerization techniques. Preferably the emulsifier is partially or fully removed by dialysis.

The polymerizable surfactant may act as the emulsifier during the polymerization and prevent the polymer dispersion obtained from agglomerating. Therefore in another aspect the present invention provides an aqueous polymer dispersion obtainable by the polymerization of the following monomers in water:
acrylic acid or an ester thereof in the range 40 to 80% by weight;
methacrylic acid or an ester thereof in the range 20 to 60% by weight; and
a polymerizable surfactant in the range 0.01 to 9% by weight.

In yet another aspect the present invention provides an aqueous polymer dispersion obtainable by the polymerization of the following monomers in water:
ethyl acrylate in the range 40 to 80% by weight;
methyl methacrylate in the range 20 to 60% by weight;
and a monomer of formula I in the range 0.01 to 9% by weight.

In another aspect the invention provides a film for use in coating pharmaceutical formulations obtainable by removal of water from one of the aqueous dispersions described above.

In another aspect the invention provides an aqueous film coating dispersion for use in coating pharmaceutical formulations to provide controlled release which comprises a copolymer between:
acrylic acid or an ester thereof in the range 40 to 80% by weight;
methacrylic acid or an ester thereof in the range 20 to 60% by weight; and
a polymerizable surfactant in the range 0.01 to 9% by weight.

In yet another aspect the invention provides an aqueous film coating dispersion for use in coating pharmaceutical formulations to provide controlled release which comprises a copolymer between:
ethyl acrylate in the range 40 to 80% by weight;
methyl methacrylate in the range 20 to 60% by weight;
and a monomer of formula I in the range 0.01 to 9% by weight
   wherein m is an integer from 1-55, R1 is hydrogen or methyl, and R2 is hydrogen or a carbon chain having 1 to 20 carbon atoms.

Optionally, the film coating can include one or more pharmaceutically acceptable additives\excipients. The film coat is deposited from a water-containing liquid.

In another aspect, the invention provides a film coat covering a pharmaceutical core wherein the core comprises a pharmacologically active ingredient and the film coat comprises a copolymer of:
acrylic acid or an ester thereof in the range 40 to 80% by weight;
methacrylic acid or an ester thereof in the range 20 to 60% by weight; and
a polymerizable surfactant in the range 0.01 to 9% by weight.

In yet another aspect, the invention provides a film coat covering a pharmaceutical core wherein the core comprises a pharmacologically active ingredient and the film coat comprises a copolymer of:
ethyl acrylate in the range 40 to 80% by weight;
methyl methacrylate in the range 20 to 60% by weight;
and a monomer of formula I in the range 0.01 to 9% by weight 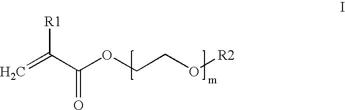
   wherein m is an integer from 1-55,
R1 is hydrogen or methyl, and
R2 is hydrogen or a carbon chain having 1 to 20 carbon atoms.

The pharmacologically active ingredient can be any active ingredient. In one embodiment, the active ingredient is a beta-blocking adrenergic agent such as metoprolol or a pharmaceutically acceptable salt thereof. The metoprolol salt can be a tartrate, succinate, fumarate or benzoate salt.

In another aspect of the invention, the invention provides a pharmaceutical formulation including:
a) a pharmaceutical core comprising a pharmacologically active ingredient; and
b) a film coat comprising a copolymer of the following monomers:
acrylic acid or an ester thereof in the range 40 to 80% by weight;
methacrylic acid or an ester thereof in the range 20 to 60% by weight; and
a polymerizable surfactant in the range 0.01 to 9% by weight.

In yet another aspect of the invention, the invention provides a pharmaceutical formulation including:
a) a pharmaceutical core comprising a pharmacologically active ingredient; and
b) a film coat comprising a copolymer of the following monomers:
ethyl acrylate in the range 40 to 80% by weight;
methyl methacrylate in the range 20 to 60% by weight;
and a monomer of formula I in the range 0.01 to 9% by weight 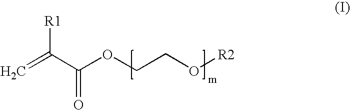
   wherein m is an integer from 1-55,
R1 is hydrogen or methyl, and
R2 is a carbon chain having 1 to 20 carbon atoms or is hydrogen.

Optionally, the film coating can include one or more pharmaceutically acceptable additives\excipients. The film coat is deposited from a water-containing liquid, preferably from water.

The invention also provides a pharmaceutical formulation including a pharmacologically active ingredient which is provided in a plurality of beads wherein each of the beads is coated with a film coat as described herein. In one embodiment, the formulation can be a controlled-release formulation. The pharmacologically active ingredient is preferably an ingredient that has activity in the treatment of cardiovascular or gastrointestinal diseases. In one embodiment, the pharmacologically active ingredient is a beta-blocking adrenergic agent such as metoprolol or a pharmaceutically acceptable salt thereof. The metoprolol salt is a tartrate, succinate, fumarate or benzoate salt.

The invention further comprises a process for the preparation of a polymer comprising polymerizing in water in the presence of an emulsifier:
acrylic acid or an ester thereof in the range 40 to 80% by weight;
methacrylic acid or an ester thereof in the range 20 to 60% by weight; and
a polymerizable surfactant in the range 0.01 to 9% by weight.

The invention also further comprises a process for the preparation of a polymer comprising polymerizing in water in the presence of an emulsifier:
ethyl acrylate in the range 40 to 80% by weight;
methyl methacrylate in the range 20 to 60% by weight;
and a monomer of formula I in the range 0.01 to 9% by weight 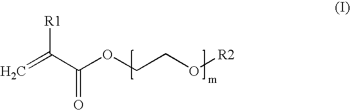
   wherein m is an integer from 1-55,
R1 is hydrogen or methyl, and
R2 is a carbon chain having 1 to 20 carbon atoms or is hydrogen.

The invention also includes a process for the preparation of a film coating composition as described herein which comprises polymerizing the dispersions containing ethyl acrylate, methyl methacrylate, and the monomer described herein in the range of 1 to 100° C. for example 10 to 100° C. The reactions are started with an initiator as known in the art.

The invention further includes a process to prepare a formulation as described herein which is coated by the above described film coating.

The invention also includes a process to prepare a formulation which includes a plurality of beads with a film coating as described above.

Preferred values of the substituents R1 and R2 and the integer m in the polymer, the dispersion and the film coat and the processes for preparing each will now be given. It will be understood that these values may be used in embodiments described hereinbefore and hereinafter. In one embodiment m is an integer from 2-55. In a preferred embodiment, R1 is hydrogen or methyl. For example, R1 is hydrogen. For example, R1 is methyl. In a preferred embodiment R2 has 11 to 18 carbon atoms, e.g., 12, 13, 14, 15, 16, or 17 carbon atoms. For example, R2 has 11 carbon atoms. For example, R2 has 12 carbon atoms. For example, R2 has 13 carbon atoms. For example, R2 has 14 carbon atoms. For example, R2 has 15 carbon atoms. For example, R2 has 16 carbon atoms. For example, R2 has 17 carbon atoms. For example, R2 has 18 carbon atoms. Preferably R2 is H, or has 11, 13 or 18 carbon atoms. In a preferred embodiment the integer m is preferably from 2 to 55, e.g., m is an integer from 2 to 4, e.g., 2, 3 or 4. In another embodiment, m is an integer from 10 to 25, for example, 10, 11, 12, 13, 14, 15, 16, 17, 18, 19, 20, 21, 22, 23, 24, or 25. Most preferably m is 4, 9, 10 or 25.

In one embodiment, the monomer is defined as m is 4, R1 is hydrogen and R2 has 13 carbon atoms. In another embodiment, the monomer is defined as m is 10, R1 is hydrogen and R2 has 11 carbon atoms. In yet another embodiment, the monomer is defined as m is 25, R1 is hydrogen and R2 has 18 carbon atoms. In a still further embodiment m is 9, R1 is methyl and R2 is H. These monomers are also known as alkyl polyethoxy acrylate monomers.

In still yet another embodiment, the monomer is defined as m is 1, R1 is methyl and R2 is hydrogen. This monomer is also known as a hydroxyethyl methacrylate.

The film coating as described herein requires the addition of no extra additives\excipients. Of course, for different reasons it might be appropriate to add additional additives\excipients to meet special requirements, e.g., during extreme processing and conditions, mixing, etc. Such additives\excipients are known for those skilled in the art and can be but are not limited to:
antiadherents (e g talc and magnesium stearate), binders (e g sucrose, glucose, starch and is cellulose), coloring agents (e g titanium dioxide and iron oxide), diluents (e g lactose, mannitol and sorbitol), disintegrants (e g starch derivatives, clays, alginates and gums), glidants (e g silica and paraffins), lubricants (e g waxes and sodium stearyl fumarate), surfactants (anionics, eg sodium lauryl sulfate; cationics, e g hexyldodecyl ammonium bromide; non-ionic, e g Tween), and polymers (cellulose derivatives, e g hydroxypropyl cellulose; polysaccharides, e g xanthan; other natural polymers like proteins e g albumin; natural rubbers; synthetic polymers, e g poly(meth)acrylates, polyamides, polyanhydrides, polyvinylalcohol, polyvinylacetate, PEO-PPO block-co-polymers, polyvinylpyrrolidone). The use of these materials are described in, e g, H A Lieberman, L Lachman (Eds): Pharmaceutical Dosage Forms: Tablets Volume 1 (Marcel Dekker Inc, NY 1980), ME Aulton (Ed): Pharmaceutics, The science of dosage form design (Churchill Livingstone 1988), and A H Kibbe (Ed): Handbook of Pharmaceutical Excipients (American Pharmaceutical Association, Washington D.C. and Pharmaceutical Press, London, 2000). The amounts of such additives\excipients depend on the specific purpose as described in these references.

Also, to obtain different effects such as suitable release rates, processing improvements, etc, the acrylic polymer dispersion described above can be mixed with other acrylic polymer dispersions, or a mixture of other acrylic polymer dispersions including one or more commercial dispersions. Examples of commercial polymer dispersions include, but are not limited to Kollicoat® SR30D (BASF), Kollicoat® EMM30D (BASF), Eudragit® RL30D (Röhm), Eudragit® RS30D (Röhm), Eudragit® NE30D (Röhm), Aquacoat® ECD (FMC), Surelease® (Colorcon), etc.

Suitably the film coat has a thickness in the range of 1 to 100 micrometers, preferably in the range of 5 to 50 micrometers and more preferably in the range of 10 to 30 micrometers.

The film coating described herein can be used to coat a pharmaceutical core which includes one or more pharmacologically active ingredients, and optionally one or more pharmaceutically acceptable additives or excipients. The pharmacologically active as ingredient can be provided in a plurality of beads and coated with a film coat as defined above. Such film coated beads may be provided in sachets or formulated as a capsule, for example a hard gelatin capsule, or compressed to form tablets using known methods with the optional addition of other pharmaceutically acceptable additives. Coated beads to be compressed into a tablet are obtained by conventional techniques known to those skilled in the alt. Also, during this process suitable agents can be added. For example, during the tabletting step suitable fillers, e.g., microcrystalline cellulose, talc, sodium stearyl fumarate etc. can be utilised to give acceptable compression characteristics of the formulation, e.g., hardness of the tablet.

Suitably the beads have a diameter in the range of 0.01-2 mm, preferably in the range of 0.05-11.0 mm and more preferably in the range of 0.1-0.7 mm.

Optionally the beads may contain an insoluble core onto which the active ingredient has been deposited for example by spraying. Suitable materials for the inert core are silicon dioxide, glass or plastic resin particles. Suitable types of plastic material are pharmaceutically acceptable plastics such as polypropylene or polyethylene preferably polypropylene. Such insoluble cores have a size diameter in the range of 0.01-2 mm, preferably in the range of 0.05-0.5 mm and more preferably in the range of 0.1-0.3 mm.

The present invention also includes a controlled-release formulation wherein the pharmacologically active ingredient is controlled over a long period of time, for example longer than 3 hours, e.g., up to 24 hours, in comparison to an immediate release tablet. Preferably the pharmacologically active ingredient is released from the formulation over 10 to 24 hours, for example over 18 to 22 hours. Preferably the pharmacologically active ingredient has activity in the treatment of cardiovascular or gastrointestinal diseases.

In a preferred embodiment, the invention provides a controlled release metoprolol formulation where a metoprolol core comprising metoprolol or a pharmaceutically acceptable salt thereof and optionally one or more pharmaceutically acceptable excipients or additives, is coated with a film coating described herein. The core including metoprolol or a pharmaceutically acceptable salt thereof can be a plurality of beads which comprise metoprolol or a pharmaceutically acceptable salt thereof. Preferably the beads have an inert core as described previously.

Suitable pharmaceutically acceptable salts of metoprolol include the tartrate, succinate, fumarate or benzoate salts and especially the succinate salt. The S-enantiomer of metoprolol or a salt thereof, particularly the benzoate salt or the sorbate salt, may also be used.

Preferred percentage compositions for the film coating now follow. It should be understood that these preferences also apply to all other embodiments for example copolymers, dispersions, formulations and film coats. It should also be understood that each preference for one component may be combined with any of the preferences of the other component.

Suitably the amount of acrylic acid or an ester thereof in the film coating is in the range 40 to 80% by weight. Preferably the amount of acrylic acid or an ester thereof in the film coating is in the range 50 to 70% by weight. More preferably the amount of acrylic acid or an ester thereof in the film coating is in the range 55 to 60% by weight.

Suitably the amount of ethyl acrylate in the film coating is in the range 40 to 80% by weight. Preferably the amount of ethyl acrylate in the film coating is in the range 50 to 70% by weight. More preferably the amount of ethyl acrylate in the film coating is in the range 55 to 60% by weight.

Suitably the amount of methacrylic acid or an ester thereof in the film coating is in the range 20 to 60% by weight, for example 20 to 40% by weight. Preferably the amount of methacrylic acid or an ester thereof in the film coating is in the range 30 to 50% by weight. More preferably the amount of methacrylic acid or an ester thereof in the film coating is in the range 40 to 45% by weight.

Suitably the amount of methyl methacrylate in the film coating is in the range 20 to 60% by weight, for example 20 to 40% by weight. Preferably the amount of methyl methacrylate in the film coating is in the range 30 to 50% by weight. More preferably the amount of methyl methacrylate in the film coating is in the range 40 to 45% by weight.

Suitably the amount of the polymerizable surfactant in the film coating is in the range 0.01 to 10% by weight, for example 0.01 to 9% by weight, or for example 0.02 to 10% by weight or for example 1 to 10% by weight. Preferably the amount of the polymerizable surfactant in the film coating is in the range 0.05 to 9% by weight. More preferably the amount of the polymerizable surfactant in the film coating is in the range 0.5 to 5% by weight.

Suitably the amount of the compound of formula I in the film coating is in the range 0.01 to 10% by weight, for example 0.01 to 9% by weight or for example 0.02 to 10% by weight or for example 1 to 10% by weight. Preferably the amount of the compound of formula I in the film coating is in the range 0.05 to 9% by weight. More preferably the amount of the compound of formula I in the film coating is in the range 0.5 to 5% by weight.

It will be understood that these preferred compositions also apply to the copolymer and the copolymer in the dispersion.

Another group of preferred polymers for this use comprises blends where one component has a Tg below room temperature and the other component has a Tg above room temperature.

Preferably the amount of ethyl acrylate for the low Tg component in the film coating is in the range 50 to 70% by weight. More preferably the amount of ethyl acrylate for the low Tg component in the film coating is in the range 65 to 70% by weight.

Preferably the amount of methyl methacrylate for the low Tg component in the film coating is in the range 20 to 40% by weight. More preferably the amount of methyl methacrylate for the low Tg component in the film coating is in the range 30 to 35% by weight.

Suitably the amount of the compound of formula I for the low Tg component in the film coating is in the range 0.01 to 9% by weight. Preferably the amount of the compound of formula I for the low Tg component in the film coating is in the range 0.05 to 9% by weight. More preferably the amount of the compound of formula I for the low Tg component in the film coating is in the range 0.5 to 5% by weight.

Preferably the amount of ethyl acrylate for the high Tg component in the film coating is in the range 40 to 60% by weight. More preferably the amount of ethyl acrylate for the high Tg component in the film coating is in the range 45 to 50% by weight.

Preferably the amount of methyl methacrylate for the high Tg component in the film coating is in the range 40 to 60% by weight. More preferably the amount of methyl methacrylate for the high Tg component in the film coating is in the range 50 to 55% by weight.

Suitably the amount of the compound of formula I for the high Tg component in the film coating is in the range 0.01 to 9% by weight. Preferably the amount of the compound of formula I for the high Tg component in the film coating is in the range 0.05 to 9% by weight. More preferably the amount of the compound of formula I for the high Tg component in the film coating is in the range 0.5 to 5% by weight.

Suitably the water-containing liquid comprises water and a water miscible organic liquid for example lower alkanols e.g. ethanol, propanol or isopropanol. From a safety point of view it is preferred that the proportion of the organic is kept to a minimum but small amounts are tolerable for example in the range of 0 to 20% by volume. Preferably the liquid is water.

The film-coating composition is particularly suitable for use as an aqueous film-coating composition wherein the film-coat is applied using water as the liquid. This process is particularly advantageous as it removes the need to use environmentally unacceptable organic solvents.

In another aspect the present invention provides processes for the synthesis of suitable acrylic polymers. Therefore there is provided a process for the synthesis of water based acrylic polymer dispersions.

In another aspect the present invention provides processes for the preparation of the film-coating composition. Therefore there is provided a process for the preparation of a film-coating.

In another aspect the present invention provides a process for film coating a pharmaceutical core wherein a film coating composition as defined above is applied to a core. Preferably the film coating composition is applied by spraying for example in a fluidised bed with top spray or bottom spray techniques. Other coating methods used are coating in standard coating pans with perforated pans, Accela-cota, immersion swords, Glatt, or immersion tubes as described in “Theory and Practice in Industrial Pharmacy” edited by Lachman, published by Lea and Feabiger 1986 3^{rd} edition.

In another aspect the invention provides a process to prepare a film coat as defined above comprising removing the liquid from a film coating composition as defined above. Suitably the liquid is removed by evaporation for example by spray drying for example in a fluidised bed. When coating the tablets in a standard coating pan, hot air is used for drying.

In yet another aspect the invention provides a process to prepare a formulation as defined above comprising coating a pharmaceutical core as defined above with a film coating composition as defined above and optionally containing pharmaceutically acceptable additives as defined above.

In a further aspect the invention provides a process to prepare a formulation in which the pharmacologically active ingredient is provided as a plurality of beads as defined above comprising coating the plurality of beads with a film-coating composition as defined above and optionally containing pharmaceutically acceptable additives or excipients as defined above.

### EXAMPLES

The following examples are non-limiting and are given by way of illustration only. It will be appreciated by those skilled in the art that the examples are to be looked upon as guidelines, and the invention is not restricted to the exemplified compositions. A wide range of combinations is possible to give film coatings having the necessary properties required for each specific application.

In the examples five different acrylate monomers of formula I were used

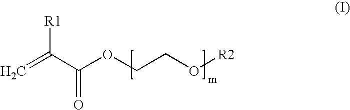

wherein m, R1 and R2 are defined in Table 1 below.

TABLE 1

| Monomer | m | R1 | R2 |
|---|---|---|---|
| M1 | 4 | H | C13 |
| M2 | 10 | H | C11 |
| M3 | 25 | H | C18 |
| M4 | 1 | CH₃ | H |
| M5 | 9 | CH₃ | H |

### Example 1

### Synthesis of Polymer Dispersions Using M1, M2 and M3

Polymerizations were carried out using ethyl acrylate, methyl 2-methylacrylate and monomers M1, M2 and M3

The following ingredients were used to prepare dispersions D1, D2 and D3:

| D1 | | |
|---|---|---|
| Water | 677.55 | g |
| Ethyl acrylate | 217.75 | g |
| Methyl methacrylate | 108.88 | g |
| Monomer M1 | 2.18 | g |
| Sodium dodecyl sulfate (SDS) | 2.18 | g |
| NaHCO₃ (0.005 M) | 0.27 | g |
| Na₂S₂O₈ (initiator) | 1.67 | g |
| D2 | | |
| Water | 677.42 | g |
| Ethyl acrylate | 218.23 | g |
| Methyl methacrylate | 109.12 | g |
| Monomer M2 | 3.75 | g |
| SDS | 2.19 | g |
| NaHCO₃ (0.005 M) | 0.27 | g |
| Na₂S₂O₈ | 1.72 | g |
| D3 | | |
| Water | 675.31 | g |
| Ethyl acrylate | 218.85 | g |
| Methyl methacrylate | 109.43 | g |
| Monomer M3 | 7.15 | g |
| SDS | 2.19 | g |
| NaHCO₃ (0.005 M) | 0.27 | g |
| Na₂S₂O₈ | 1.72 | g |

The monomers were cleaned from inhibitor by filtering through a column of aluminum oxide. Polymerizations in nitrogen atmosphere were carried out under continous feed conditions at 70° C. in a calorimetric reactor (stirring rate 100 rpm) by first forming a pre-emulsion with SDS in water. The dispersions were purified by dialysis.

### Example 2

### Synthesis of Polymer Dispersion Using M4

The following components were used to produce dispersion D4:

| | | |
|---|---|---|
| Water | 600 | g |
| Ethyl acrylate | 120 | g |
| Methyl methacrylate | 70 | g |
| Monomer M4 | 10 | g |
| (hydroxyethyl methacrylate, see Table 1) | | |
| SDS | 3 | g |
| Sodium hydroxide (1 M) | 2.3 | ml |
| K₂S₂O₈ (initiator) | 0.6 | g |

The monomers were distilled to remove the inhibitors. The emulsion polymerization was carried out in a tightly capped water-jacketed vessel equipped with nitrogen bubbling, and stirred. The monomers, SDS and sodium hydroxide were dispersed in the water and stirred (50 rpm). The temperature was raised to 50° C. and the initiator was added. The polymerization was run for 20 hours and the temperature was set to 70° C. for 2 hours. The dispersion was then filtered and cooled.

### Example 3

### Preparation of Films, F1-F4 from Examples 1 and 2

Free films F1-F4 respectively from dispersions D1-D4 were obtained by pouring approximately 10 ml of each dispersion in Teflon moulds. The moulds were then placed in a controlled climate chamber at 25° C. and 60% relative humidity for drying and film forming during 19 hours.

Results:

The stickiness of the films was tested by simple manual handling of the films. The films were tested in a permeability experiment, as described in Example 5.

### Example 4

Comparative Coating: Preparation of Films from GMS/PS80/Eudragit NE30D.

Three mixtures of GMS, PS80 and NF-30D were prepared. Different mixing conditions of GMS and PS80 were used to examine the influence of the stirring rate. Thus, first GMS and PS80 were mixed according to either A, B, or C below. Then, appropriate amounts of this dispersion were added to NE30D to give the intended compositions. The same amounts of GMS, PS80, and NE30D® were used, namely 0.225 g GMS, 0.090 g PS80, and 15.0 g NE30D which gave dispersions with 1.5% w/w GMS (GMS/particle ratio=5%). as described in Petereit et al. 1995 (supra) and Petereit and Weisbrod, (1999) (supra):
A: 1 hour; homogenizer at 6000 rpm; 65° C.;
B: 20 min; homogenizer at 3000 rpm; 65° C.;
C: 4 hours; magnet stirring; 65° C.

Free films (10×10 cm²) of the three dispersions were obtained by pouring approximately 10 ml of each dispersion in Teflon moulds, which were set aside at 25° C., 60% relative humidity for drying and film-formation during 18 hrs.

### Example 5

### Permeability of Free Films

Pieces of the films F1, F4, A, B, and C prepared according to Examples 1-4 were mounted in diffusion chambers consisting of two chambers separated by a free film (Hjärtstam, Thesis, Chalmers University of Technology, Göteborg 1998). The transport of labelled water was followed from the donor side to the receiver side over the membrane at 25° C. Appropriate volumes (typically 0.5 mL) were taken from the receiver side at different times. The permeability (m²s⁻¹×10¹²) of a film was calculated from the amount of labelled water passing through the membrane in time.

Results:

The results from the permeability experiments are shown in Table 2. The results clearly show that the films F1 to F4 show an unexpected low permeability compared to the known films A, B, and C. It is seen that highly variable permeability was obtained with the three GMS/PS80/NE30D dispersions. However, the trend in the data suggested that a protocol which produced better dispersed GMS particles gave a lower permeability (A better than B better than C). Nevertheless, it was not possible to obtain the low permeability shown by films F1 and F4 obtained from the dispersions D1 and D4 according to this invention. Moreover, the permeability of films F1 and F4 were comparable to what could be expected with a free film typical for the organic solvent based film (O) used for coating of the drug metoprolol (Lindstedt, Ragnarsson, and Hjärtstam, Int J Pharmaceutics 56, 261 (1989). Thus, superior quality of free film could be obtained with the present invention with no additives and with no processing before film-preparation.

TABLE 2
Permeability of free films

| | Film | | | | | |
|---|---|---|---|---|---|---|
| | F1 | F4 | A | B | C | O |
| Permeability (m² s⁻¹ × 10¹²) | 1.4 | 3.1 | 30.1 | 40.5 | 51.0 | >1.8 |
| | | | | | | (1.8-10) |

### Example 6

### Preparation of Metoprolol Succinate Pellets Coated with D4

Metoprolol succinate beads (size fraction 0.40-0.63 mm)(prepared as described in EP 220143) were coated with film dispersion D4. The dispersion was sprayed onto the beads in a laboratory-scale, fluidbed topspray apparatus. The coating conditions were as follows:

| | | |
|---|---|---|
| Bed weight | 500 | g |
| Coating solution | 300 | g |
| Spraying rate | 6-9 | g/min |
| Atomising air pressure | 2 | bar |
| Fluidising air flow rate | 30 | m³/h |
| Inlet air temp. | 43° | C. |
| Outlet air temp. | 23° | C. |

Results: No sticking of pellets occurred during the process.

### Example 7

### Release of Metoprolol Succinate from Pellets Coated with D4

The release of metoprolol from about 150 mg pellets according to Example 6 was evaluated in a USP dissolution apparatus No. 2 (rotating paddle, 100 rpm). The test medium was 500 ml of phosphate buffer with a pH of 6.8 and ionic strength equal to 0.1 M. The temperature of the bath was set to 37° C. Samples were withdrawn for analysis (absorbance of metoprolol at 274 nm in a 1 cm cell). Amounts of released metoprolol were determined from measurements of the absorbance of a standard metoprolol solution based on the same medium as used in the release experiments.

Results

TABLE 3
Fraction released from pellets

| | Time/hrs | | | | | | | | |
|---|---|---|---|---|---|---|---|---|---|
| | 1 | ⁻2 | 4 | 6 | 8 | 10 | 12 | 16 | 20 |
| % released | 6.6 | 12.2 | 22.1 | 30 | 37.8 | 45.3 | 52.2 | 65.6 | 78.1 |

The results in Table 3 show that a close to constant release profile with modified release properties up to 20 hrs can be achieved.

### Example 8

### Synthesis of Polymer Dispersions Using M5

Polymerizations were carried out using ethyl acrylate, methyl 2-methylacrylate and monomer M5.

The following ingredients were used to prepare dispersions D5, D6 and D7:

| D5 | | |
|---|---|---|
| Water | 659.85 | g |
| Ethyl acrylate | 222.57 | g |
| Methyl methacrylate | 111.26 | g |
| Monomer M5 | 2.48 | g |
| Sodium dodecyl sulfate (SDS) | 2.27 | g |
| NaHCO₃ (0.005 M) | 0.31 | g |
| Na₂S₂O₈ (initiator) | 1.82 | g |
| D6 | | |
| Water | 660.02 | g |
| Ethyl acrylate | 191.58 | g |
| Methyl methacrylate | 142.55 | g |
| Monomer M5 | 2.49 | g |
| SDS | 2.27 | g |
| NaHCO₃ (0.005 M) | 0.31 | g |
| Na₂S₂O₈ | 1.82 | g |
| D7 | | |
| Water | 660.10 | g |
| Ethyl acrylate | 163.53 | g |
| Methyl methacrylate | 170.72 | g |
| Monomer M5 | 2.49 | g |
| SDS | 2.27 | g |
| NaHCO₃ (0.005 M) | 0.30 | g |
| Na₂S₂O₈ | 1.82 | g |

The monomers were cleaned from inhibitor by filtering through a column of aluminum oxide. Polymerizations in nitrogen atmosphere were carried out under continous feed conditions at 70° C. in a calorimetric reactor (stirring rate 100 rpm) by first forming a pre-emulsion with SDS in water. The dispersions were purified by dialysis.

### Example 9

### Preparation of Metoprolol Succinate Pellets Coated with D6

Metoprolol succinate beads (size fraction 0.40-0.63 mm) were coated with film dispersion D6. The polymer content in the dispersion was set to 15%. The dispersion was sprayed onto the beads in a laboratory-scale, fluidbed bottom spray apparatus. The coating conditions were as follows:

| | | |
|---|---|---|
| Bed weight | 200 | g |
| Coating solution | 277 | g |
| Spraying rate | 4.5 | g/min |
| Atomising air pressure | 2.5 | bar |
| Fluidising air flow rate | 35 | m³/h |
| Inlet air temp. | 35° | C. |
| Outlet air temp. | 21° | C. |

Results: No sticking of pellets occurred during the process.

### Example 10

### Release of Metoprolol Succinate from Pellets Coated with D6

The release of metoprolol from about 150 mg pellets according to Example 9 was evaluated in a USP dissolution apparatus No. 2 (rotating paddle, 100 rpm). The test medium was 500 ml of phosphate buffer with a pH of 6.8 and ionic strength equal to 0.1 M. The temperature of the bath was set to 37° C. Samples were withdrawn for analysis (absorbance of metoprolol at 274 nm in a 1 cm cell). Amounts of released metoprolol were determined from measurements of the absorbance of a standard metoprolol solution based on the same medium as used in the release experiments.

Results

TABLE 4
Fraction released from pellets

| | Time/hrs | | | | | | | | |
|---|---|---|---|---|---|---|---|---|---|
| | 1 | 2 | 4 | 6 | 8 | 10 | 12 | 16 | 20 |
| % released | 26 | 41 | 57 | 66 | 72 | 76 | 79 | 83 | 86 |

The results in Table 4 show that a close to constant release profile with modified release properties up to 20 hrs can be achieved.

### Example 11

### Preparation of Metoprolol Succinate Pellets Coated with D5/D7=30/70

Metoprolol succinate beads (size fraction 0.40-0.63 mm) were coated with film dispersion blend D5/D7=30/70. The polymer content of the dispersion was set to 15%. The dispersion was sprayed onto the beads in a laboratory-scale, fluidbed bottom spray apparatus. The coating conditions were as follows:

| | | |
|---|---|---|
| Bed weight | 200 | g |
| Coating solution | 277 | g |
| Spraying rate | 4.5 | g/min |
| Atomising air pressure | 2.5 | bar |
| Fluidising air flow rate | 35 | m³/h |
| Inlet air temp. | 35° | C. |
| Outlet air temp. | 21° | C. |

Results: No sticking of pellets occurred during the process.

### Example 12

### Release of Metoprolol Succinate from Pellets Coated with D5/D7=30/70

The release of metoprolol from about 150 mg pellets according to Example 11 was evaluated in a USP dissolution apparatus No. 2 (rotating paddle, 100 rpm). The test medium was 500 ml of phosphate buffer with a pH of 6.8 and ionic strength equal to 0.1 M. The temperature of the bath was set to 37° C. Samples were withdrawn for analysis (absorbance of metoprolol at 274 nm in a 1 cm cell). Amounts of released metoprolol were determined from measurements of the absorbance of a standard metoprolol solution based on the same medium as used in the release experiments.

Results

TABLE 5
Fraction released from pellets

| | Time/hrs | | | | | | | | |
|---|---|---|---|---|---|---|---|---|---|
| | 1 | 2 | 4 | 6 | 8 | 10 | 12 | 16 | 20 |
| % released | 17 | 26 | 34 | 39 | 53 | 57 | 60 | 65 | 69 |

The results in Table 5 show that a close to constant release profile with modified release properties up to 20 hrs can be achieved.

1. A copolymer comprising the following monomers:
acrylic acid or an ester thereof in the range 40 to 80% by weight;
methacrylic acid or an ester thereof in the range 20 to 60% by weight; and
a polymerizable surfactant in the range 0.01 to 9% by weight,
wherein the percentages refer to the percentage amount by weight of each monomer in the sum of the monomer weights.

2. The copolymer according to claim 1, wherein the copolymer comprises the following monomers:
ethyl acrylate in the range 40 to 80% by weight;
methyl methacrylate in the range 20 to 60% by weight; and
a monomer of the formula I and in the range 0.01 to 9% by weight: 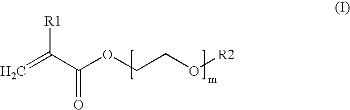
wherein m is an integer from 1-55,
R1 is hydrogen or methyl, and
R2 is hydrogen or a carbon chain having 1 to 20 carbon atoms.

3. An aqueous polymer dispersion prepared by polymerizing the following monomers in water and in the presence of an emulsifying agent:
acrylic acid or an ester thereof in the range 40 to 80% by weight;
methacrylic acid or an ester thereof in the range 20 to 60% by weight; and
a polymerizable surfactant in the range 0.01 to 9% by weight,
wherein the percentages refer to the percentage amount by weight of each monomer in the sum of the monomer weights.

4. An aqueous polymer dispersion prepared by polymerizing the following monomers in water and in the presence of an emulsifying agent:
ethyl acrylate in the range 40 to 80% by weight;
methyl methacrylate in the range 20 to 60% by weight;
and a monomer of the formula I and as described in claim 1 in the range 0.01 to 9% by weight: 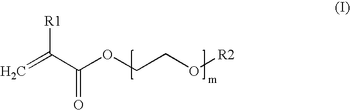
wherein m is an integer from 1-55,
R1 is hydrogen or methyl, and
R2 is hydrogen or a carbon chain having 1 to 20 carbon atoms and
wherein the percentages refer to the percentage amount by weight of each monomer in the sum or the monomer weights.

5. An aqueous polymer dispersion prepared by polymerizing the following monomers in water and in the presence of an emulsifying agent:
acrylic acid or an ester thereof in the range 40 to 80% by weight;
methacrylic acid or an ester thereof in the range 20 to 60% by weight; and
a polymerizable surfactant in the range 0.01 to 9% by weight,
wherein the percentages refer to the percentage amount by weight of each monomer in the sum of the monomer weights.

6. An aqueous polymer dispersion prepared by polymerizing the following monomers in water in the presence of an emulsifying agent:
ethyl acrylate in the range 40 to 80% by weight;
methyl methacrylate in the range 20 to 60% by weight;
and a monomer of the formula I and in the range 0.01 to 9% by weight: 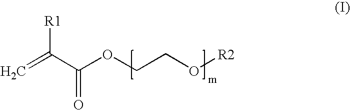
wherein m is an integer from 1-55,
R1 is hydrogen or methyl, and
R2 is hydrogen or a carbon chain having 1 to 20 carbon atoms, and
wherein the percentages refer to the percentage amount by weight of each monomer in the sum of the monomer weights.

7. An aqueous polymer dispersion prepared by polymerizing the following monomers in water:
acrylic acid or an ester thereof in the range 40 to 80% by weight;
methacrylic acid or an ester thereof in the range 20 to 60% by weight; and
a polymerizable surfactant in the range 0.01 to 9% by weight
wherein the percentages refer to the percentage amount by weight of each monomer in the sum of the monomer weights.

8. An aqueous polymer dispersion prepared by polymerizing the following monomers in water:
ethyl acrylate in the range 40 to 80% by weight;
methyl methacrylate in the range 20 to 60% by weight;
and a monomer of the formula I and in the range 0.01 to 9% by weight: 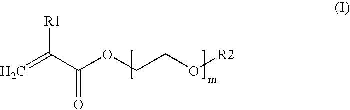
wherein m is an integer from 1-55,
R1 is hydrogen or methyl, and
R2 is hydrogen or a carbon chain having 1 to 20 carbon atoms, and
wherein the percentages refer to the percentage amount by weight of each monomer in the sum of the monomer weights.

9. A film for use in coating pharmaceutical formulations, wherein the film is prepared by removing water from an aqueous dispersion according to any one of claims 3 to 8.

10. A pharmaceutical formulation comprising:
a) a pharmaceutical core comprising a pharmacologically active ingredient; and
b) a film coating comprising a film according to claim 9.

11. A pharmaceutical formulation comprising a pharmacologically active ingredient which is provided in a plurality of beads wherein each of the beads is coated with a film according to claim 9.

12. The formulation according to claim 10 or claim 11, wherein the formulation is a controlled release formulation.

13. The formulation according to claim 11 or 12, wherein the pharmacologically active ingredient has activity in the treatment of cardiovascular or gastrointestinal diseases.

14. The formulation according to claim 13, wherein the pharmacologically active ingredient is a beta-blocking adrenergic agent.

15. The formulation according to claim 14 in which the pharmacologically active ingredient is metoprolol or a pharmaceutically acceptable salt thereof.

16. The formulation according to claim 15, wherein the metoprolol salt is the tartrate, succinate, fumarate or benzoate salt.

17-22. (canceled)

23. A process for the preparation of a copolymer, wherein the process comprises polymerizing the following monomers in water and in the presence of an emulsifier:
ethyl acrylate in the range 40 to 80% by weight;
methyl methacrylate in the range 20 to 60% by weight; and
a monomer of the formula I and in the range 0.01 to 9% by weight: 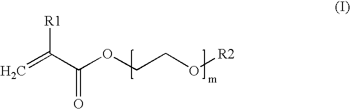
wherein m is an integer from 1-55,
R1 is hydrogen or methyl, and
R2 is hydrogen or a carbon chain having 1 to 20 carbon atoms,
wherein the percentages refer to the percentage amount by weight of each monomer in the sum of the monomer weights.

24. The process according to claim 23, wherein the process is carried out at a temperature in the range of 1 to 100° C.

25. A process for preparing a pharmaceutical formulation comprising a pharmaceutically active ingredient contained in a pharmaceutical core or in a plurality of beads, wherein the process comprises coating the pharmaceutical core or each of the beads with a film coating dispersion according to any one of claims 3 to 8.

26. The aqueous polymer dispersion according to claim 5 or 6, wherein the emulsifying agent is an emulsifier with a molecular weight lower than 15 kD, and wherein the emulsifying agent is partially or fully removed after the polymerization reaction.
